(19) United States
(12) Patent Application Publication
(10) Pub. No.: US 2003/0203165 A1
(43) Pub. Date: Oct. 30, 2003

(54) Computer generated decorative graphic article for application to a surface

(76) Inventors: Joy Sharon Nobles, Hendersonville, TN (US); Henry Leonard Schwind, Hendersonville, TN (US)

Correspondence Address: David Masterson, 721 Hampton Cove, Franklin, TN, 37064, US

(21) Appl. No.: 10/420,014

(22) Filed: Apr. 18, 2003

Related U.S. Application Data
(60) Provisional application No. 60/376,399, filed on Apr. 30, 2002.

(51) Int. Cl. B32B 3/00

(52) U.S. Cl. 428/195.1

(57) ABSTRACT

In one aspect of the present invention, a method for creating a decorative graphic article for application to a wood flooring surface using a computer system is disclosed. A graphic design representing a desired work of art and a plurality of design elements each representing a unique property of a material surface are created. A designer uses the design elements to overlay various locations in the graphic design to form the decorative image. The decorative image is printed on a substrate having adhesive properties and the substrate is affixed to a flooring surface to create a high quality, low cost floor design.

This application claims priority to U.S. Provisional Patent Application Serial No. 60/376,399 filed on Apr. 30, 2002.

### TECHNICAL FIELD

This invention relates generally to a computer generated, decorative graphic article and; more particularly, to a computer generated, decorative graphic article for application to a flooring surface.

### BACKGROUND ART

Decorative flooring treatments, such as wood medallions, are a popular accessory item in today's home environment. Such flooring treatments come in many shapes and sizes and are typically made of exotic wood, marble, granite, shells, and other material inlays. The use of such materials, particularly exotic woods which come from our scarce rain forests are becoming rare, make flooring treatments quite expensive. In addition, the inlays are very intricate and are typically created by the hands of skilled craftsmen. Several hundred pieces may form a single design, which may take several weeks for a skilled craftsman to complete. Such wood flooring treatments are difficult to integrate into an existing floor, resulting in a high cost of installation. Thus, such decorative flooring treatments are only installed in the homes of the affluent.

The present invention is directed toward overcoming one or more of the problems as set forth above.

### DISCLOSURE OF THE INVENTION

In one aspect of the present invention, a method for creating a decorative graphic article for application to a surface using a computer system is disclosed. The computer system includes a plurality of graphic designs representing a desired work of art and a plurality of design elements representing unique properties of a material surface. A designer uses the design elements to overlay various locations in the graphic design to form a decorative image. The decorative image is printed on a substrate having adhesive properties and the substrate is affixed to a surface.

### BRIEF DESCRIPTION OF THE DRAWINGS

For a better understanding of the present invention, reference may be made to the accompanying drawings in which:

FIG. 1 illustrates a side profile of one embodiment of a decorative graphic article of the present invention;

FIG. 2 illustrates a side profile of another embodiment of the decorative graphic article of the present invention;

FIG. 3 illustrates a block diagram of the computer generation system associated with the present invention;

FIG. 4 illustrates a graphic design of the present invention;

FIGS. 5A, 5B, and 5C illustrate design elements of the present invention;

FIG. 6 illustrates a decorative image of the present invention; and

FIG. 7 illustrates a decorative graphic article of the present invention in application with a flooring surface.

### BEST MODE FOR CARRYING OUT THE INVENTION

The present invention is embodied by a decorative graphic article that simulates expensive hardwood and other decorative material inlays. As compared to real wood inlays, the present invention produces an article that is inexpensive to manufacture, requires a simplified installation process, and does not require the use of exotic woods to create an attractive design.

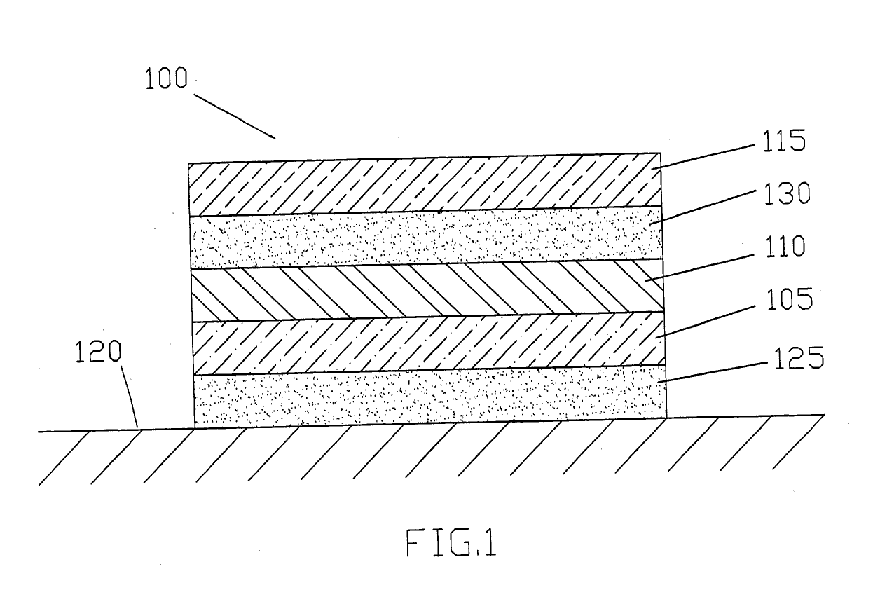

Referring to FIG. 1, a side profile of a decorative graphic article 100 of the present invention is shown. The decorative graphic article 100 is constructed of a multi-layered film that may have up to three principal components: a base film 105, a decorative image 110 formed on the base film 105 and a protective film 115 that covers and protects the decorative image 110. The decorative graphic article 100 is shown in one particular application, viz., affixed to a flooring surface 120. The base film 105 includes oppositely disposed surfaces, one surface having an adhesive coating 125 adapted to adhere to the flooring surface 120 and the other surface being imageable and adapted to display the decorative image 110. The term imageable as used herein means that the base film 105 is compatible with one or more continuous or discontinuous color layers which may be deposited thereon by conventional printing processes. The base film 105 should be flexible enough to conform to the flooring surface 120, yet rigid enough for strength. The base film 105 may be transparent, translucent, substantially clear or colored. Preferably, the base film 105 is made of a polymeric material, such as a vinyl film.

The top surface of the base film 105, or surface opposite the adhesive coating 125, is suitable for application of one or more color layers to form the decorative image 110. Multiple colored layers are preferably digitally created and deposited on the base film 105. The color layers may be deposited on the base film 105 by many well known printing, painting, etching, or photo-etching techniques to form the decorative image 110; including, for example, screen printing, electrographic (electrostatic and electrophotographic) printing, offset printing, thermal inkjet printing, laser printing or thermal mass transfer, or other such techniques. One preferred printing process to deposit ink on a base film having vinyl properties is by a conventional ink jet printer.

An adhesive 125 is used to affix the graphic article to the flooring surface 120. The adhesive should be applied or deposited to the bottom of the base film with a thickness of 2 mils to about 10 mils (0.05 to 0.25 millimeters) with 5 mils (0.13 millimeters) being the preferred thickness for most applications. A wide variety of adhesives 125 are available and are conventionally employed to bond graphic articles to a surface. Pressure-sensitive adhesives are useful with the preferred base film 105 being pretreated with adhesive 125 which in turn is covered with a removable II silicone coated release liner (not shown) to provide protection from dirt and contaminates prior to application of the graphic article 100 to a surface 120.

The multi-layered, graphic article 100 may be manufactured in a variety of methods. The decorative image 110 is typically produced in an electronic or digital format and is applied to the base film 105 using widely available printing techniques to form an image layer. The protective film 115 may be laminated to the base film 105 using a thermal heat or pressure adhesive process to protect the decorative image 110 and to provide for rigidity of the decorative graphic article 100. The protective film 115 may be pre-coated with a substantially clear pressure sensitive adhesive 130. The clear adhesive 130 is typically protected by a release liner (not shown) that is removed during the lamination process. The release liner is preferably striped away as the protective film 115 is applied to the base film 105.

The protective film 115 may have a smooth surface or an embossed surface to provide for texture and effect. The protective film 115 may be made from a variety of materials depending on the degree of protection required for the decorative image 110, and may be substantially clear or tinted to enhance the decorative image 110. Preferred materials for use as the protective film 115 include vinyl and polyurethane based polymeric films. Polyurethane based and pressure sensitive adhesives have been found to work well to form the adhesive layer 130 between the protective film 115 and base film 105. It is important that the adhesive 130 is clear so as not to obscure the decorative image 110 when the protective film 115 is applied to the base film 105 to form the graphic article 100.

The decorative graphic article 100 may be manufactured in such a manner that the edges are beveled to minimize the appearance of the article 100 as sitting on top of the flooring surface 120. For example, the edges may be beveled by cutting the edge or compressing the edge.

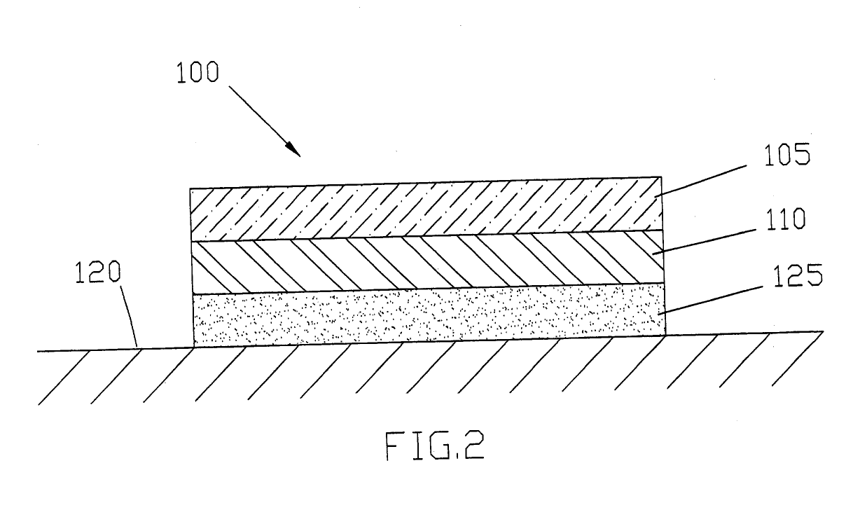

In an alternate embodiment shown in FIG. 2, the decorative graphic article 100 may be comprised of a two layer construction. In this embodiment, the decorative image 110 may be applied to the bottom of the base film 105, between the base film 105 and the adhesive layer 125. This embodiment is referred to as a “buried graphic” construction. This construction eliminates the use of the protective film 115 to reduce the thickness of the graphic article 100. The results in the graphic article 100 to appear as though it were integrated with the flooring surface 120.

Advantageously, a computer system generates a multicolored, digital representation of the decorative image 110. Such a computer system will typically use a graphic program of a type well known in the art to create the decorative image. One example of a graphic program is that produced by Adobe such as Illustrator Photoshop.

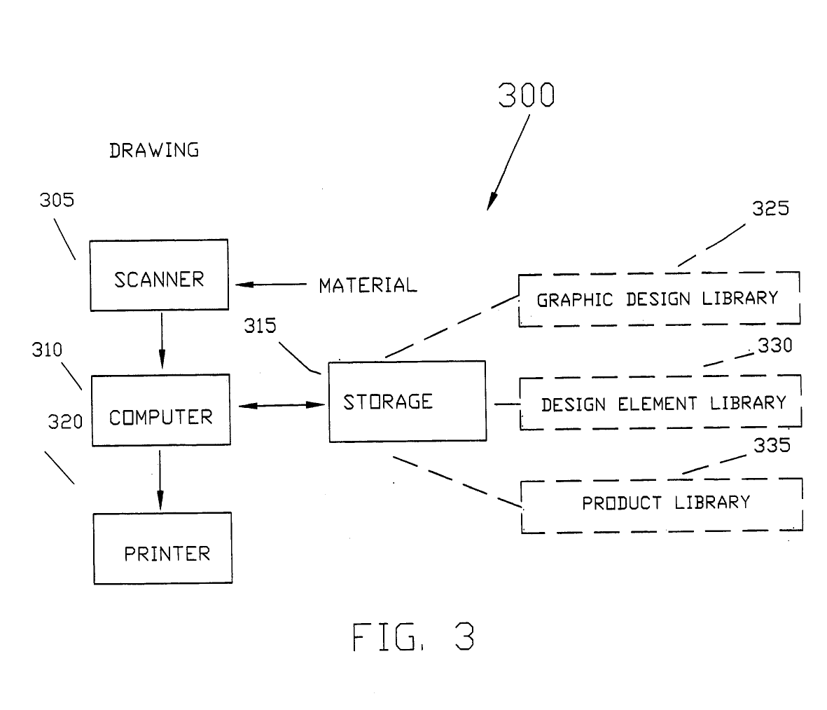

Reference is now made to FIG. 3 which shows a block diagram of the computer system 300 associated with the present invention to create the decorative graphic article 100. A scanner 305 may be used to convert a desired texture of a material surface, such as a wood veneer, into a digital image. The scanned image may be scanned at a specified d.p.i to achieve the desired resolution and may be converted to a .tif, .jif, .jpeg or other type of digital graphic file and stored on a computer 310. The scanner 305 may additionally be used to convert a drawing of a particular work of art or graphic design into a digital image. The computer 310 may store the digital images on a hard drive, or other storage media 315, having electronic, magnetic or optical properties. A graphic designer will use the computer system 300 to create a decorative image from the stored digital images and print the decorative image on a substrate by a printer 320, or store the decorative image on the storage media 315 for later use.

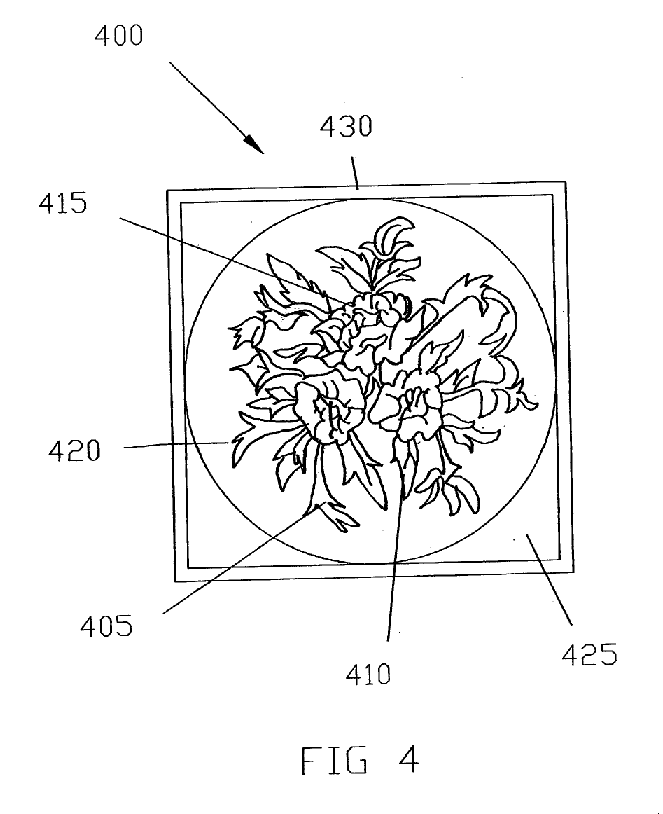

A plurality of digital images representing unique graphic designs form a graphic design library 325, which may be stored on the storage media 315. Likewise a plurality of digital images each representing unique surface properties of a material form a design element library 330, which may be stored on the storage media 315. Each graphic design includes aesthetic properties such as a work of art, design or pattern; for example, an elaborate pattern of marquetry. A graphic design may be hand drawn or computer generated using any suitable computer graphic program that is readily available, such as Adobe Illustrator or Adobe Photoshop. The designer may create or select a desired graphic design from the graphic design library 325. The designer may then modify the selected design, or add other designs from the graphic design library 325 to the selected design. One example of a graphic design is shown in FIG. 4, which shows a medallion 400 having floral and leaf patterns. The medallion 400 displays a floral pattern arranged with large leaves 405, small leaves 410 and blossoms 415. The floral pattern is outlined by a circle 420, which is set in a square 425 having a border 430. In this example, the graphic design may have been selected by the designer exactly as shown, or arranged by the designer from several design elements, e.g., the floral and leaf patterns, and the circle and square having a border.

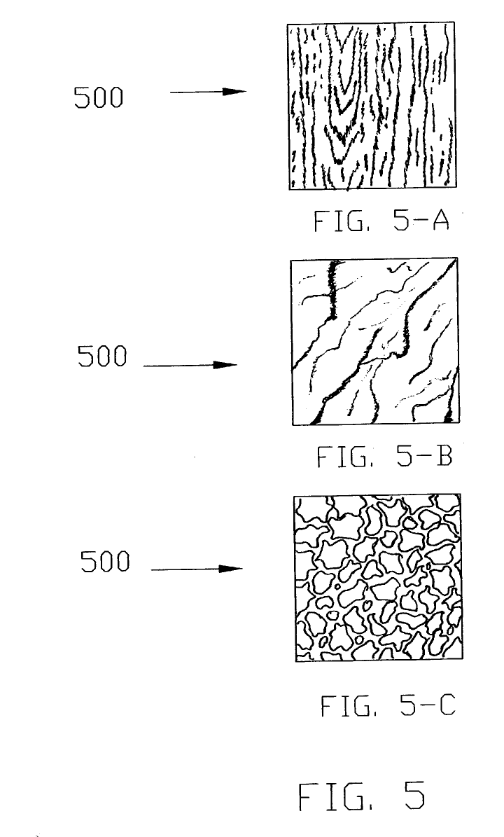

The graphic design is then embellished by the designer with the use of the design elements from the design element library 330 to create a decorative image. The design element library 330 includes a plurality of digital images that represent unique properties or aspects of material surfaces, such as species of wood, stone and other material inlay representations, and which may also include color, grain direction and patterns. For example, the design element library images may represent any particular type of wood, metal, stone, shell, ivory and other material inlay. One method of creating a design element library image is by scanning the surface of a particular material, such as a particular wood veneer, and creating a digital image representing the scanned surface. Examples of design elements 500 are shown in FIGS. 5A. B and C. FIG. 5A illustrates a section of a wood grain veneer of Brazilian rosewood, FIG. 5B a section of dark emperador marble, and FIG. 5C a general pattern of stone pebbles. Advantageously, the designer will select the unique material properties represented by the design element library and will add the design elements to the graphic design to give it a realistic appearance. The design element library, like the graphic design library, may include an almost infinite number of images, limited solely by the designer's imagination. The computer software associated with the present invention additionally provides the designer to further customize the graphic design by adding color, grain direction, and grain density.

The designer may additionally be provided with a material list by which certain of the various designs associated with the graphic design may be enhanced using predetermined material properties specified by the material list. The material list typically will specify the material properties, which may include color, grain direction and patterns, that are to be associated with a particular graphic design. Thus, as described, the designer uses the various design element images from the design element library to “fill in” or overlay desired sections of the graphic design, then further customizes the graphic design by adding color and applicable wood grain, to form the decorative image. This provides the designer with a great degree of artistic freedom.

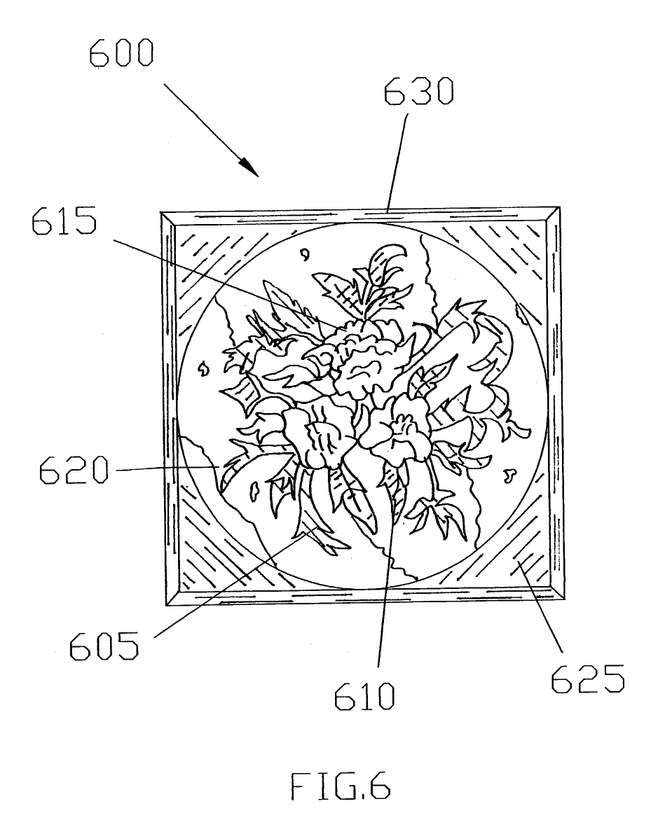

Once the decorative image is complete with the graphic design enhanced with the various design elements, the decorative image is ready to be printed and added to the product library. A completed decorative image is shown in FIG. 6. The medallion 600, includes a floral pattern arranged with large leaves 605 simulated in swiss pear, for example, small leaves 610 simulated in boxwood, for example, and blossoms 615 simulated in sycamore, for example. The floral design is shown encircled 620 in a walnut burl simulation, for example. The circle 620 is set in a square 625 having corners simulated in jatoba, for example. The medallion 600 includes a square border 630 simulated in Brazilian ebony, for example. Note, that although the floral medallion 600 is a representation of exotic wood inlays, other materials such as stones or metals may equally be represented.

Once the designer has completed creating the decorative image, the image may be stored on the storage medium 315 and added to a product library 335, which includes a plurality of digital images each representing a unique decorative image.

The decorative graphic article 100 can be applied to the flooring surface by removing the release liner from the base film 105, placing the decorative graphic article 100 on the flooring surface 120, and applying equal pressure to the decorative graphic article in a continuous motion. To facilitate application, the surface of the adhesive 125 may be treated to allow repositioning of the decorative graphic article 100 before a bond is formed. Once positioned, the decorative graphic article 100 can be squeegeed flat by a roller to remove entrapped air and to provide a good adhesive bond with the underlying surface 120. To ensure good adhesion of the decorative graphic article to a finished hardwood flooring surface, the flooring surface must be clean and free from surface dirt, chemical residues and other foreign matter prior to application of the decorative graphic article, which may be accomplished by using standard flooring cleaning products.

One particular method of applying the decorative graphic article to a topcoated or “finished” hardwood flooring surface is as follows. Clean the flooring surface with any well known cleaning solution, such as that manufactured by Basic Coatings, Inc. under brand name “Basic Coatings Intensive Floor Treatment (IFT)” as a first stage cleaning treatment. Next, rinse the flooring surface with a damp mop and clean water. Clean the floor again with another cleaning solution such as that manufactured by Basic Coatings under brand name “Basic Coating Squeaky Cleaner solution” as a second stage cleaning treatment. The flooring surface should be allowed to dry followed by the application of a bonding agent, a product also supplied by Basic Coatings, Inc. Once the bonding agent is dry the decorative graphic article can then be applied to the flooring surface. Next, a topcoat can be applied to the flooring surface such as that manufactured by Basic Coatings, Inc. under the brand name “TyKote.” The topcoat is typically applied with a sponge mop to create a thin, uniform layer over the decorative graphic article. The applied area should have a wet appearance and puddles should be avoided. Once the first application of the topcoat has dried, a second application should be applied. The floor may then be open to light traffic after waiting 24 hours to dry.

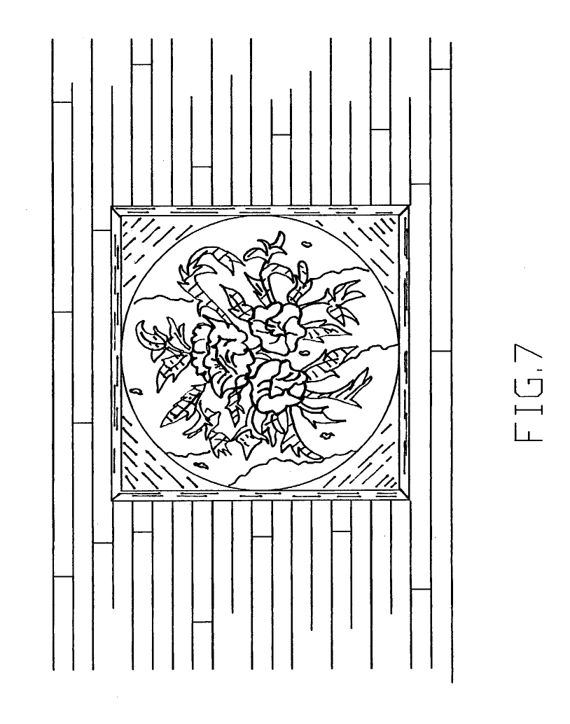

If the decorative graphic article is being installed on a new unfinished or re-sanded hardwood floor, the decorative graphic article should be applied after the wood is sanded, stained and treated, but before the hardwood floor has been topcoated. The application of the flooring topcoat over the entire surface of the floor provides additional protection for the decorative graphic article. Advantageously, once the decorative graphic article is installed it will resemble a high quality medallion, or marquetry, of various wood inlays, for example, as shown in FIG. 7.

The present invention may be used as a decorative graphic article 100 for use on a hardwood flooring surface. However, the present invention 100 is equally applicable to decorate other wood surfaces such as wood boxes, grand father clocks, tables, panels and doors, fireplace surrounds, picture frames, musical instruments, cabinets, armoires, humidors, etc. The decorative graphic article 100 may represent any type of motif or design of marquetry representing wood and other material inlays including tortoiseshell, ivory, mother of pearl, and metals including brass, silver, copper, gold, stainless steel, or the like.

Thus, while the present invention has been particularly shown and described with reference to the preferred embodiment above, it will be understood by those skilled in the art that various additional embodiments may be contemplated without departing from the spirit and scope of the present invention.

1. A method for creating a decorative graphic article for application to a surface using a computer system, comprising the steps of
creating a digital image of a graphic design and storing the digital image of the design in a graphic design library having a plurality of digital images representing unique graphic designs;
creating a digital image of a design element and storing the digital image of the design element in a design element library having a plurality of digital images representing unique design elements;
selecting at least one graphic design and design element, and creating a decorative image having properties of the selected graphic design and design element;
printing the decorative image on a substrate having adhesive properties; and
affixing the substrate to a surface.

2. A method, as described in claim 1, including the step of using the design elements to overlay various locations in the graphic design to form the decorative image.

3. A method, as described in claim 2, including the step of creating the graphic design digital image as a representation of a work of art.

4. A method, as described in claim 3, including the step of creating the graphic design digital image as a representation of marquetry arranged in a desired pattern.

5. A method, as described in claim 4, including the step of creating the design element digital image as a representation of a specific property of a material surface.

6. A method, as described in claim 5, including the step of creating the design element digital images as a representation of various properties of wood veneer to create a decorative graphic article that represents marquetry comprised of wood inlays.

7. A method, as described in claim 6, including the step of creating the graphic design with the use of a computer graphic program.

8. A method, as described in claim 7, wherein the step of creating the design element includes the step of optically scanning a wood veneer into the computer system.

9. A method of creating a decorative graphic article for application on a surface using a computer system, comprising:
creating a graphic design representing a desired work of art;
creating a plurality of design elements each representing a unique property of a material surface;
using the design elements to overlay various locations in the graphic design to form a decorative image;
printing the decorative image on a substrate having adhesive properties; and
affixing the substrate to a surface.

10. A method, as described in claim 9, including the step of creating a graphic design library that includes a plurality of digital images representing unique graphic designs.

11. A method, as described in claim 10, including the step of creating a design element library that includes a plurality of digital images representing unique design elements.

12. A method, as described in claim 11, including the step of creating the graphic design as a representation of marquetry arranged in a desired pattern.

13 A method, as described in claim 12, including the step of creating the design elements as a representation of various properties of wood veneer to create a decorative graphic article that represents marquetry comprised of wood inlays.

14. A method, as described in claim 13, including the step of creating the graphic design with the use of a computer graphic program.

15. A method, as described in claim 14, wherein the step of creating the design element includes the step of optically scanning a wood veneer into the computer system.

16. A decorative graphic article, comprising:
a base film having oppositely disposed top and bottom surfaces, the bottom surface having an adhesive coating adapted to adhere to a flooring surface and the top surface being imageable and adapted to display a decorative image, wherein the decorative image is a representation of wood inlays arranged in a predetermined pattern; and
a protective top film adapted to cover the decorative image.

17. A decorative graphic article, as described in claim 16, wherein the base film is made of a polymeric material.

18. A decorative graphic article, as described in claim 17, wherein the top surface of the base film is suitable for application of color layers to form the decorative image.

19. A decorative graphic article, as described in claim 17, wherein a computer generates a digital representation of the decorative image.

20. A decorative graphic article, as described in claim 19, wherein multiple colored layers are deposited on the base film through a printer to provide a high quality image.

21. A decorative graphic article, as described in claim 20, wherein the top surface is embossed to provide for a textured appearance.

22. A decorative graphic article, comprising:
a base film having oppositely disposed top and bottom surfaces, the bottom surface adapted to display a decorative image representing an arrangement of wood inlays, the top surface adapted to protect the decorative image; and
an adhesive coating applied to the bottom surface and adapted to bond the base film to a flooring surface.

23. A decorative graphic article, as described in claim 22, wherein the base film is made of a polymeric material.

24. A decorative graphic article, as described in claim 23, wherein the bottom surface of the base film is suitable for application of color layers to form the decorative image.

25. A decorative graphic article, as described in claim 24, wherein a computer generates a digital representation of the decorative image.

26. A decorative graphic article, as described in claim 25, wherein multiple colored layers are deposited on the base film through a printer to provide a high quality image.

27. A decorative graphic article, as described in claim 21, wherein the top surface of the base film is embossed to provide for a textured appearance.
